(19) United States
(12) Patent Application Publication
(10) Pub. No.: US 2016/0269536 A1
(43) Pub. Date: Sep. 15, 2016

(54) Emergency Information Conveyance System

(71) Applicant: Clayton Hunnighan, Morristown, NJ (US)

(72) Inventor: Clayton Hunnighan, Morristown, NJ (US)

(21) Appl. No.: 15/069,799

(22) Filed: Mar. 14, 2016

Related U.S. Application Data
(60) Provisional application No. 62/132,445, filed on Mar. 12, 2015.

(51) Int. Cl. H04M 1/725; H04N 21/2743; H04W 4/02; H04N 21/2187; H04W 4/22; H04L 29/06

(52) U.S. Cl. CPC H04M 1/72541; H04W 4/22; H04L 65/4069; H04W 4/02; H04N 21/2187; H04N 21/2743

(57) ABSTRACT

An emergency information conveyance system is provided. The system comprises a cellular smartphone and an activatable computer program within the cellular smartphone. Upon activation of the computer program, the cellular smartphone records and sends streaming information to a 911 operator in real time.

### CLAIM OF PRIORITY

This patent application claims priority under 35 USC 119 (e) (1) from U.S. Provisional Patent Application Ser. No. 62/132,445 filed Mar. 12, 2015, of common inventorship herewith entitled, “911 Vision,” which is incorporated herein by reference as though the same were set forth in its entirety.

### FIELD OF THE INVENTION

The present invention pertains to the field of emergency response, and more specifically to the field of providing alert and video data for emergency teams.

### BACKGROUND OF THE INVENTION

Perhaps nothing is so jarring as witnessing a crime, emergency situation or accident. When these incidences occur, a witness may become overwhelmed with emotion or panic, and details of the event become clouded and difficult to remember. When police or rescue personnel show up to the scene of the event, a witness can get their facts confused, resulting in an unreliable testimonial. Eyewitness misidentification is a single greatest cause of wrongful convictions nationwide and approximately seventy five percent of criminal convictions that'are overturned in the United States are a result of eye witness testimony being disproved through DNA testing. A vast majority of witnesses to criminal activity, as well as people who witness vehicle collisions or other emergency situations, wish to convey accurate information to the authorities so that those parties in the wrong are punished accordingly and innocent parties are spared wrongful prosecutions.

The prior art has put forth several designs for providing alert and video data for emergency teams. Among these are:

US Patent 2013/0002880 to Lawrence Levinson and Deepinger Singh describes a system and method for generating security alerts for a facility. The system can comprise a server, cameras operable to stream video to the server or other storage location and to a surveillance center of the facility, input devices, a first module operable to assign one or more codes to the facility, associate one or more cameras with each code, and associate response guidelines with each code. A second module is operable to receive one code of the one or more codes from one of the one or more input devices, notify the facility assigned to the one code based on the response guidelines, stream video from the one or more cameras associated with the one code to the surveillance center of the facility, and generate the security alert based on the video stream. In one aspect, a user can send a video feed along with the code.

U.S. Pat. No. 8,588,733 to Daniel Lee Ferguson and Tony Charles Lonstein describes a system and method for providing a conduit to send information to emergency services from a wireless device. Systems and methods for registering an alarm button on a wireless device and sending to public or private emergency services a provider's information related to the wireless device including its location, information about a wireless device end user or subscriber associated with the wireless device, and information recorded by one or more wireless devices during and subsequent to the time the alarm button is activated.

U.S. Pat. No. 8,417,090 to Matthew Joseph Fleming describes a system or method of transmitting and receiving surveillance video and alarm data and converting proprietary video formats into a single, standardized format for viewing on a multiplicity of devices at the surveillance location by authorized emergency responders.

None of these prior art references describe the present invention.

### SUMMARY OF THE INVENTION

It is an object of the present invention to provide an application for cellular smartphones that sends streaming video of crimes, emergencies or other accidents to 911 operators in real time.

The present invention is an emergency information conveyance system. The system comprises a cellular smartphone and an activatable computer program within the cellular smartphone. Upon activation of the computer program, the cellular smartphone records and sends streaming information to a 911 operator in real time.

In addition, the present invention includes a method for conveying information to a 911 operator. The method comprises providing a cellular smartphone, programming the cellular smartphone with a computer program, activating the computer program, and recording and sending streaming information to the 911 operator in real time.

The present invention further includes an emergency information conveyance system comprising a cellular smartphone having a camera, a microphone, a GPS, and a timer mechanism and an activatable computer program within the cellular smartphone. Upon activation of the computer program, the cellular smartphone records and sends streaming information to 911 operators in real time. The computer program allows the smartphone to record and simultaneously send a live video and audio stream to a 911 operator, allows the smartphone to send a geographic location of the smartphone to a 911 operator, and allows the smartphone to display time, date, and amount of elapsed time during recording and streaming of the information.

### BRIEF DESCRIPTION OF THE DRAWINGS

FIG. 1 is a perspective view illustrating an emergency information conveyance system, constructed in accordance with the present invention, with a start screen of the application software being displayed on a smart phone screen.

FIG. 2 is a perspective view illustrating the emergency information conveyance system, constructed in accordance with the present invention, with a record mode selection screen of the application software being displayed on the smart phone screen.

FIG. 3 is a perspective view illustrating the emergency information conveyance system, constructed in accordance with the present invention, with a 911 texting screen of the application software being displayed on the smart phone screen.

FIG. 4 is a perspective view illustrating the emergency information conveyance system, constructed in accordance with the present invention, with a 911 audio record screen of the application software being displayed on the smart phone screen.

FIG. 5 is a perspective view illustrating the emergency information conveyance system, constructed in accordance with the present invention, with a 911 video screen of the application software being displayed on the smart phone screen.

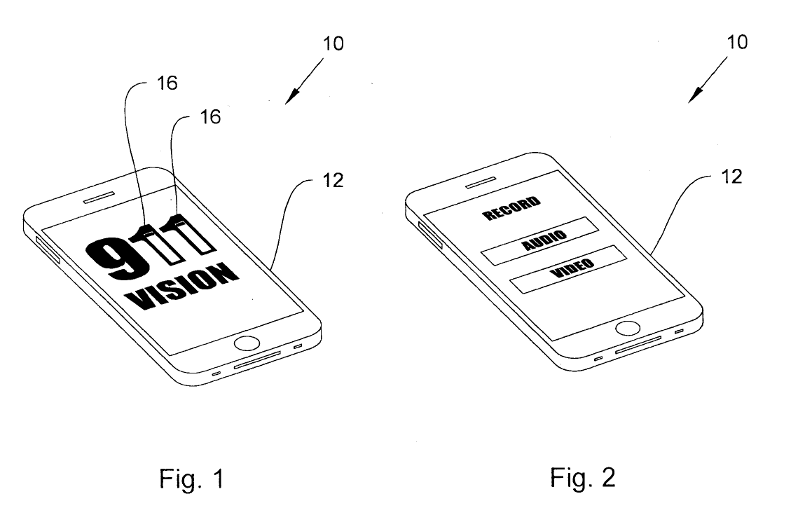

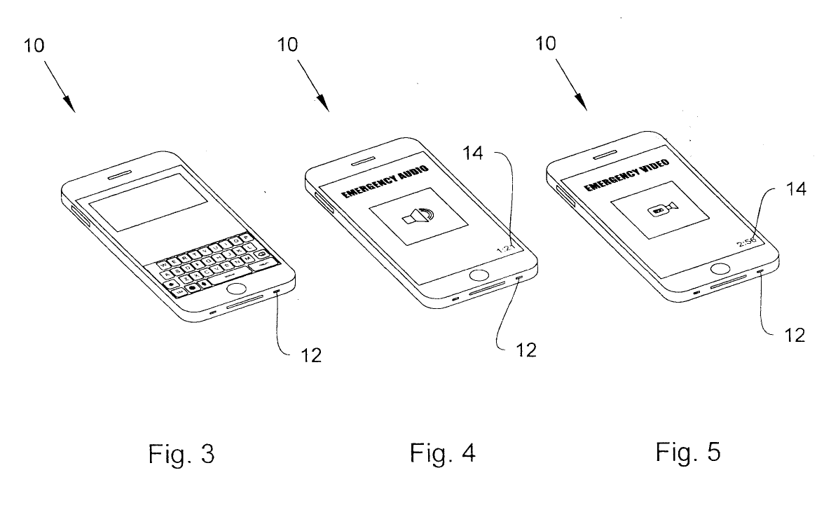

### DETAILED DESCRIPTION OF THE INVENTION

The present invention, hereinafter referred to as an Emergency Information Conveyance System, indicated generally at 10, is an application for cellular smartphones 12 that sends streaming video of crimes, emergencies, or other accidents to 911 operators in real time. The Emergency Information Conveyance System 10 provides users with an effective way to convey accurate information to first responders, thus facilitating expeditious and proper resolution of these events. The Emergency Information Conveyance System 10 is accessible for use during criminal trials and courtroom disputes, providing tangible visual evidence for use during such legal proceedings enabling witnesses to criminal activity, accidents or other emergency events to convey real time accurate information to first responders and law enforcement personnel.

The Emergency Information Conveyance System 10 of the present invention is a downloadable software accessed from popular software application outlets such as the Apple App Store, Amazon.com, and iTunes. Preferably, a nominal fee is charged with the initial purchase of the Emergency Information Conveyance System 10 and then periodic updates are available as they are developed.

The Emergency Information Conveyance System 10 of the present invention is configured in a similar manner as traditional application software that has an interactive menu with which the user installs, activates, and operates the System 10. After downloading the application to a smartphone 12 or other electronic device, the user follows instructional prompts and accepts the terms and conditions for utilizing the application.

Upon accessing the Emergency Information Conveyance System 10 of the present invention, the user has a dual finger slide 16 activation to alert the 911 operator. Then, easily followed prompts are initiated that enable the user to record video and simultaneously send this live video stream to a local 911 operator. Utilizing the existing video camera of the smartphone 12, the Emergency Information Conveyance System 10 records both video and audio. A timer mechanism 14 is located in the corner of the smartphone 12 with the program accurately displaying the time, date, and amount of time that has passed during the video shoot.

Should one be witness to a crime, accident, or other event, they need only retrieve their smartphone 12 and press the Emergency

Information Conveyance System 10 application icon. The program is activated and initiated by the dual finger slide 16 and a 911 operator is called by the smartphone 12. Holding the smartphone 12 and directing its camera toward the event, the user records the activity at hand while they speak to the 911 operator and convey information regarding the emergency. In addition to a streaming video, this program provides a 911 operator with exact information pertaining to the geographic location of the event using GPS technology. Police and first responders are provided concise information that enables them to discern and arrive at the designated location in an expeditious manner.

The video and corresponding information transmitted by the Emergency Information Conveyance System 10 is recorded automatically to the 911 operator's server and the user's cellular smartphone 12. This information can be backed up simultaneously to the SIM card of the smartphone 12 as well as to a companion software program installed on the user's home computer. In this manner, evidence is recorded in real time, turned over to the police or other responders and utilized in the event of a trial or other courtroom dispute. Using the Emergency Information Conveyance System 10 ensures true details of the incident are recorded and accessible, thus eliminating the confusion and mistakes associated with eyewitness testimony. Enabling first responders and police to quickly arrive on the scene, the 911 Vision proves an invaluable assist enabling these officials to quickly discern the identity of perpetrators, as well as determine fault in accidents or other misadventures. Universal in design, the Emergency Information Conveyance System 10 can be installed on virtually any smartphone 12 and easily accessed on demand.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An emergency information conveyance system comprising:
a cellular smartphone; and
an activatable computer program within the cellular smartphone;
wherein upon activation of the computer program, the cellular smartphone records and sends streaming information to a 911 operator in real time.

2. The emergency information conveyance system of claim 1 wherein the information pertains to crimes, emergencies, and accidents.

3. The emergency information conveyance system of claim 1 and further comprising:
a dual finger slide for activating the computer program to dial 911 and begin recording and sending of information.

4. The emergency information conveyance system of claim 1 wherein the computer program is an application software accessed from a software application outlet.

5. The emergency information conveyance system of claim 1 wherein upon activation of the computer program, the smartphone displays an interactive menu from which a user installs, activates, and operates the system.

6. The emergency information conveyance system of claim 1 wherein the smartphone has a camera, and further wherein the computer program allows the smartphone to record and simultaneously send a live video stream to a 911 operator.

7. The emergency information conveyance system of claim 6 wherein the smartphone has a microphone, and further wherein the computer program allows the smartphone to record and simultaneously send a live audio stream to a 911 operator.

8. The emergency information conveyance system of claim 1 and further comprising:
a timer mechanism for displaying time, date, and amount of elapsed time during recording and streaming of the information.

9. The emergency information conveyance system of claim 1 wherein the smartphone has a GPS, and further wherein the computer program allows the smartphone to send a geographic location of the smartphone to a 911 operator.

10. The emergency information conveyance system of claim 1 wherein the information transmitted is recorded automatically to the 911 operator's server and the cellular smartphone.

11. The emergency information conveyance system of claim 10 wherein the information is backed up simultaneously to a SIM card in the smartphone and to a companion software program installed on a distant computer, wherein the information is accessible for use during criminal trials and courtroom disputes.

12. A method for conveying information to a 911 operator, the method comprising:
providing a cellular smartphone;
programming the cellular smartphone with a computer program;
activating the computer program; and
recording and sending streaming information to the 911 operator in real time.

13. The method of claim 12 wherein the information pertains to crimes, emergencies, and accidents.

14. The method of claim 12 and further comprising:
activating the computer program to dial 911 and begin recording and sending of information by a dual finger slide.

15. The method of claim 12 and further comprising:
activating the computer program;
displaying an interactive menu on the smartphone; and
installing, activating, and operating the computer program.

16. The method of claim 12 and further comprising:
mounting a camera on the smartphone;
mounting a microphone on the smartphone;
allowing the smartphone to record and simultaneously send a live video stream to a 911 operator; and
allowing the smartphone to record and simultaneously send a live audio stream to a 911 operator.

17. The method of claim 1 and further comprising:
displaying time, date, and amount of elapsed time during recording and streaming of the information.

18. The method of claim 12 and further comprising:
mounting a GPS on the smartphone; and
allowing the smartphone to send a geographic location of the smartphone to a 911 operator.

19. The method of claim 12 and further comprising:
automatically recording the information to the 911 operator's server and the cellular smartphone.

20. An emergency information conveyance system comprising:
a cellular smartphone having a camera, a microphone, a GPS, and a timer mechanism;
an activatable computer program within the cellular smartphone;
wherein upon activation of the computer program, the cellular smartphone records and sends streaming information to 911 operators in real time;
wherein the computer program allows the smartphone to record and simultaneously send a live video stream to a 911 operator;
wherein the computer program allows the smartphone to record and simultaneously send a live audio stream to a 911 operator;
wherein the computer program allows the smartphone to send a geographic location of the smartphone to a 911 operator; and
wherein the computer program allows the smartphone to display time, date, and amount of elapsed time during recording and streaming of the information.
